(19) United States
(12) Patent Application Publication
(10) Pub. No.: US 2009/0066911 A1
(43) Pub. Date: Mar. 12, 2009

(54) PRIMER COMPOSITION, PLASTIC LENS HAVING PRIMER LAYER EMPLOYING THE SAME, AND METHOD FOR MANUFACTURING PRIMER COMPOSITION

(75) Inventors: Takako Ishizaki, Shinjuku-ku (JP); Katsuaki Uchida, Shinjuku-ku (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION, Tokyo (JP)

(21) Appl. No.: 12/207,943

(22) Filed: Sep. 10, 2008

(30) Foreign Application Priority Data
Sep. 11, 2007 (JP) 2007-235485

(51) Int. Cl. G02B 1/10; C08K 3/22; C08K 9/10; G02C 7/02; B32B 27/40; B05D 5/06

(52) U.S. Cl. 351/166; 524/430; 524/431; 523/216; 428/423.1; 427/162

(57) ABSTRACT

Disclosed is a primer composition that comprises (A) polyurethane resin particles, (B) a urethane-forming monomer and/or oligomer, and (C) oxide microparticles. A method of manufacturing a plastic lens is also disclosed. The method comprises: forming a primer layer using a primer-forming composition comprising (A) polyurethane resin particles, (B) a urethane-forming monomer and/or oligomer, and (C) oxide microparticles on at least one surface of a plastic substrate; and forming a hard coat over said primer layer to obtain a plastic lens sequentially comprising a primer layer and a hard coat on at least one surface of a plastic substrate. A plastic lens comprising a primer layer and a hard coat on at least one surface of a plastic substrate is also disclosed. The primer layer is manufactured by using the primer-forming composition.

### CROSS-REFERENCE TO RELATED APPLICATIONS

This application claims benefit of priority under 35 USC 119 to Japanese Patent Application No. 2007-235485 filed on Sep. 11, 2007, which is expressly incorporated herein by reference in its entirety.

### BACKGROUND OF THE INVENTION

1. Field of the Invention

The present invention relates to a primer composition, a plastic lens having a primer layer employing this composition, and a method for manufacturing the same.

2. Discussion of the Background

Plastic lenses scratch more easily than glass lenses. Accordingly, to prevent scratches from forming on plastic lenses, a hard coat is formed on the upper surface of the lens substrate. Further, an antireflective film is formed on the upper surface of the hard coat to suppress surface reflection by plastic lenses. Plastic lenses on which a hard coat and an antireflective film have been formed generally have poorer impact resistance than plastic lenses comprising just the lens substrate itself, or on which just a hard coat has been formed.

The technique of forming a primer layer between the hard coat and the lens substrate has been developed to increase the impact resistance of plastic lenses on which a hard coat and an antireflective layer have been formed. A polymer material capable of achieving both adhesion between the lens substrate and the hard coat and impact resistance is employed in the primer layer. Polyurethane resins are an example of resins suitably achieving both of these goals.

An interference fringe is produced when the refractive index of the primer layer differs greatly from that of the lens substrate or hard coat. It is thus desirable for the refractive index of the primer layer to differ little from those of the lens substrate and hard coat.

High refractive index lenses have been developed in recent years with the goal of reducing the thickness of plastic lenses. The use of primer layers with high refractive indexes has been examined to inhibit interference fringes in plastic lenses.

One effective method of increasing the refractive index of the primer layer is to disperse microparticles of inorganic compounds in a polyurethane resin layer. The higher the ratio of microparticles in the primer layer, the higher the refractive index of the primer layer.

However, the higher the ratio of inorganic microparticles in the primer layer, the more brittle the primer layer becomes. Impact resistance deteriorates in a plastic lens in which a high proportion of inorganic microparticles is employed in the primer layer.

Japanese Unexamined Patent Publication (KOKAI) No. 2001-201602 (Reference 1 hereinafter, which is expressly incorporated herein by reference in their entirety) discloses a technique relating to a plastic lens having a primer layer formed of polyurethane resin.

Reference 1 describes a plastic lens the primer layer of which is formed using the following primer compositions:

(1) A primer composition 1, employing polyurethane resin or an aqueous polyurethane emulsion (Samples 1 to 4);
(2) A primer composition 2, employing a urethane monomer comprised of polyisocyanate and a thiol compound (Embodiments 5 and 6);
(3) A primer composition 3, employing a sol of a metal oxide and an aqueous polyurethane emulsion (Embodiments 7 and 8);
(4) A primer composition 4, employing a metal oxide sol and a urethane monomer comprised of polyisocyanate and a thiol compound (Embodiment 9).

US 2002/0159160A1 (Reference 2 hereinafter, which is expressly incorporated herein by reference in their entirety) discloses a technique of forming a primer layer using a primer composition comprising a polyurethane latex and a (meth)acrylic resin latex.

The invention described in Reference 1 presents the following problems:

(1) Primer composition 1 above does not form a primer layer of high refractive index. Primer composition 1 is not suited to forming primer layers on lenses with high refractive indexes.
(2) Primer composition 2 above does not form a primer layer of high refractive index. Thus, primer composition 2 is not suited to forming primer layers on lenses with high refractive indexes.
(3) Primer composition 3 above can be used to obtain a primer layer of higher refractive index than primer composition 1. However, a plastic lens manufactured with primer composition 3 affords poor impact resistance.
(4) Primer composition 4 above can be used to obtain a primer layer of higher refractive index than primer composition 2. However, a plastic lens manufactured with primer composition 4 affords poor impact resistance.

The invention described in Reference 2 presents the following problems.

When a primer layer is formed with the primer composition described in Reference 2, it is difficult to achieve a uniform state of bonding between the independent polyurethane and methacrylic resin. Further, impact resistance cannot be adequately enhanced due to variation in the elasticity of junctions between the polyurethane and methacrylic acid. When a sol of an inorganic compound is introduced into such a primer composition to achieve a primer layer with a high refractive index, the impact resistance drops still further.

Accordingly, an object of the present invention is to provide a primer composition permitting the formation of a primer layer, and a method of preparing the same, that affords good adhesion between the plastic lens substrate and the hard coat and reliably achieves enhanced lens impact resistance while having a high refractive index.

A further object of the present invention is to provide a plastic lens having good adhesion between the plastic lens substrate and the hard coat, affording good lens impact resistance, and achieving good suppression of interference fringes.

The present inventors conducted extensive research into achieving the above-stated objects, resulting in the discovery that the above-stated objects could be achieved by a primer composition comprising a sol of a metal oxide, polyurethane monomer comprised of polyisocyanate and polyol, and polyurethane resin. The present invention was devised on that basis.

### SUMMARY OF THE INVENTION

A feature of the present invention relates to a primer composition comprising (A) polyurethane resin particles, (B) a urethane-forming monomer and/or oligomer, and (C) oxide microparticles.

Another feature of the present invention relates to a method of manufacturing a plastic lens, comprising:

forming a primer layer using a primer-forming composition comprising (A) polyurethane resin particles, (B) a urethane-forming monomer and/or oligomer, and (C) oxide microparticles on at least one surface of a plastic substrate; and

forming a hard coat over said primer layer to obtain a plastic lens sequentially comprising a primer layer and a hard coat on at least one surface of a plastic substrate.

A further feature of the present invention relates to a plastic lens comprising a primer layer and a hard coat on at least one surface of a plastic substrate, wherein said primer layer manufactured by using a primer-forming composition comprising (A) polyurethane resin particles, (B) a urethane-forming monomer and/or oligomer, and (C) oxide microparticles.

The present invention provides a plastic lens with good adhesion between plastic lens substrate and hard coat, good lens impact resistance, and a good interference fringe-suppressing effect.

More specifically, providing a primer layer with a composition comprising a polyurethane resin and a urethane-forming monomer in the present invention makes it possible to obtain a highly impact-resistant lens. Further incorporating a metal oxide sol into the composition permits the formation of a primer layer with a high refractive index. Forming such a primer layer on a lens substrate of high refractive index makes it possible to obtain a lens that forms no interference fringe and affords good impact resistance.

Other exemplary embodiments and advantages of the present invention may be ascertained by reviewing the present disclosure.

### DESCRIPTIONS OF THE EMBODIMENTS

The following preferred specific embodiments are, therefore, to be construed as merely illustrative, and not limitative of the remainder of the disclosure in any way whatsoever. In this regard, no attempt is made to show structural details of the present invention in more detail than is necessary for the fundamental understanding of the present invention, the description making apparent to those skilled in the art how the several forms of the present invention may be embodied in practice.

### [The Primer Composition]

The primer composition of the present invention is comprised of: (A) polyurethane resin particles, (B) urethane-forming monomer and/or oligomer, and (C) oxide microparticles.

The weight ratio of the (A) polyurethane resin particles, (B) urethane-forming monomer and/or oligomer, and (C) oxide microparticles is, when given as the ratio of (C) oxide microparticles to the sum of (A) polyurethane resin particles and (B) urethane-forming monomer and/or oligomer ((A)+(B)):(C), from 2:8 to 9:1, preferably from 5:5 to 9:1, and more preferably, from 6:4 to 8:2. Preparation at such a weight ratio yields a lens that does not produce an interference fringe and that affords good impact resistance, even when the lens substrate is of particularly high refractive index (such as 1.65 to 1.75).

The weight ratio of (A) polyurethane resin particles to (B) urethane-forming monomer and/or oligomer, (A):(B), is from 1:9 to 9:1, preferably from 3:7 to 7:3, and more preferably, from 4:6 to 6:4. Preparation at such a weight ratio yields a lens with good primer layer adhesion and impact resistance, even when the primer composition contains oxide microparticles.

The various compositions are described below.

### (A) The Polyurethane Resin Particles

The polyurethane resin particles contained in the primer composition of the present invention may be in the form of solvent-soluble polyurethane resin particles dispersed in a solvent of low polarity, or aqueous polyurethane resin particles that have been dispersed to form an emulsion in water. With solvent-soluble polyurethane resin particles, the liquid itself tends to deteriorate when the dispersion absorbs moisture from the atmosphere. When aqueous polyurethane resin particles are employed, deterioration tends not to occur even when the dispersion absorbs moister from the atmosphere. When the lifetime of the dispersion and the lifetime of the completed primer composition are taken into account, it is desirable to employ polyurethane resin particles in the form of aqueous polyurethane resin particles. Aqueous polyurethane resin particles also adhere well to the lens surface. A prepolymer composition containing aqueous polyurethane resin particles can also be used to enhance adhesion between the primer layer and the lens substrate.

The aqueous polyurethane resin particles desirably comprise a functional group such as a carboxyl group, hydroxyl group, amino group, or some other hydrophilic group, and are desirably in the form of an emulsion. Examples of suitable aqueous polyurethane resin particles are polyurethane resin particles manufactured from a polyol compound having a polyester skeleton with a number average molecular weight of 200 or higher, a chain-extending agent, and a polyisocyanate compound. The aqueous polyurethane resin particles desirably comprise a carboxyl group(s) as the functional group.

The emulsion of aqueous polyurethane particles may be a cationic emulsion, anionic emulsion, or nonionic emulsion. The method of preparing the emulsion is not specifically limited; examples include the self-emulsification method in which an aqueous system is produced using a hydrophilic functional group, and the emulsion polymerization method employing a surfactant. Methods of preparing cationic emulsions, anionic emulsions, and nonionic emulsions are described below.

### Cation Emulsions

Examples of methods of preparing cationic emulsions are: the method of employing a diol having a tertiary amino group as chain-extending agent to polymerize a urethane prepolymer having a terminal isocyanate group, rendering the polymer cationic with a quaternary agent or acid, or reacting a diol comprising a quaternary amino group as chain-extending agent to render it cationic; and the method of polymerizing a urethane prepolymer having a terminal isocyanate group with a polyalkylene polyamine as chain-extending agent, and then reacting it with an epihalohydrin and an acid to render it cationic.

### Anionic Emulsions

Examples of methods of preparing anionic emulsions are: the method of anionic treatment employing a dihydroxycarboxylic acid or diaminocarboxylic acid as chain-extending agent to polymerize a urethane prepolymer having a terminal isocyanate group, and then neutralizing it with an alkaline compound; and the method of anionic treatment by sulfonating a urethane prepolymer having a terminal isocyanate group obtained from an aromatic polyisocyanate and a hydrophilic polyol, and neutralizing it with a tertiary amine.

### Nonionic Emulsions

Examples of methods of preparing nonionic emulsions are: the method of dispersing with an emulsifying agent a urethane prepolymer having a terminal isocyanate group in an aqueous solution optionally comprising a diamine or the like, and conducting chain extension with water or a diamine; the method of reacting a long-chain alcohol alkylene oxide condensate (a type of nonionic surfactant) and an amine comprising a hydrophilic group such as a hydroxyl group with a urethane prepolymer having a terminal isocyanate group; and the method of reacting the above chain-extending agent with a urethane prepolymer having a terminal isocyanate group to obtain a urethane polymer, and employing an emulsifying agent to mechanically disperse it in water.

Examples of commercially available emulsion products of aqueous polyurethane resin particles that are suitable for use in the present invention are the “Adecabontiter” series from Asahi Denka, “Superflex” series from Daiichi Yakuhin Kougyou Co., Ltd., “Bondik” and “Hydran” series from Dainippon Ink and Chemicals Corporation, and the “Permalin” series from Sanyo Chemical Industries, Ltd.

(B) The Urethane-Forming Monomer and/or Oligomer

The urethane-forming monomer and/or oligomer can be selected from the group consisting of polyols and polyisocyanates, for example. A description will be given for polyols below.

### (1) The Polyol Composition

The polyol composition is not limited. Examples are: polyacrylates, polycaprolactones, polyethers, and polyesters having multiple hydroxyl groups per molecule. Polyester polyols are particularly desirable. Polyester polyols can be obtained by reacting the compounds selected from the following polybasic acids and hydroxyl compounds.

Organic acids such as isophthalic acid, phthalic acid, phthalic anhydride, hydrogenated phthalic acid, fumaric acid, dimer linoleic acid, maleic acid, and dibasic acids comprising saturated aliphatic groups can be employed as polybasic acids.

Compounds widely employed in the synthesis of polyester polyols can be employed as the hydroxyl compound. Specific examples are glycols of ethylene, propylene, butylene, hexylene, diethylene, and the like; trimethylol propane, hexanetriol, glycerin, trimethylol ethane, pentaerythritol, and mixtures of the same. Polyols with high refractive indexes that comprise aromatic rings, such as polyesters of bisphenol A and ethylene glycol or terephthalic acid and propylene glycol, can be employed.

The molecular weight of the polyol is not specifically limited. By way of example, a number average molecular weight of 200 to 5,000 is desirable. When the number average molecular weight of the polyester polyol is less than 200, the primer layer becomes excessively hard upon polymerization. When the number average molecular weight of the polyester polyol exceeds 5,000, the primer layer becomes excessively soft and film strength is lost. The preferred number average molecular weight of the polyester polyol is 500 to 3,000.

### (2) Polyisocyanate

The polyisocyanate is not specifically limited. Examples are fatty, alicyclic, and aromatic diisocyanates. Both block and non-block type polyisocyanates may be employed, but block-type isocyanates are preferred. Examples of the polyisocyanate are: hexamethylene diisocyanate, 1,3,3-trimethylhexamethylene diisocyanate, isophorone diisocyanate, 4,4′-dicyclohexylmethane diisocyanate, xylylene diisocyanate, tetramethylxylylene diisocyanate, hydrogenated xylylene diisocyanate, trilene diisocyanate, diphenylmethane diisocyanate, hydrogenated diphenylmethane diisocyanate, 1,5-napthalene diisocyanate, tetramethylxylylene diisocyanate, and other polyisocyanates and their modification products; isocyanurate, allophanate, burette, carbodiimide, and adducts thereof such as trimers. Block-type polyisocyanates in which the isocyanate groups are protected by a blocking agent are also desirable. Examples of the blocking agent are: beta-diketones, oximes, phenols, and caprolactam.

The polyisocyanate can be suitably determined based on the quantity of hydroxyl groups of the polyols being combined. Specifically, it suffices to adjust the ratio of the polyisocyanate and the polyol, expressed as a molar ratio of the isocyanate groups and hydroxyl groups, to 0.5 to 1.5, desirably 0.85 to 1.2. When this molar ratio is less than 0.5, or exceeds 1.5, there is little reactivity and impact resistance tends to diminish.

Whether or not to use a curing catalyst can be determined based on whether the polyisocyanate is blocked or unblocked, and if blocked, based on the blocking agent. Examples of the curing catalyst are fatty acid metal salts and amines. The use of a curing catalyst is effective when employing a blocked isocyanate.

The (B) urethane-forming monomer and/or oligomer containing in the primer composition of the present invention comprises both the above-described polyester polyol and polyisocyanate.

Polyurethane resin particles can be uniformly dispersed by forming an emulsion. However, the individual polyurethane resin particles remain separate, and do not combine even with adhesion. A primer layer of polyurethane resin particles is comprised of polyurethane resin particles assembled into sheet form. Since the polyurethane resin particles do not bond together, when there is impact in a direction perpendicular to adjacent planes, the shock waves tend not to disperse in a planar direction. As a result, the impact in a perpendicular direction concentrates at one point, resulting in weakened impact resistance. Boundaries between particles become weak points in terms of impact resistance. By contrast, in the present invention, polyurethane resin particles and a urethane-forming monomer (prepolymer) capable of reacting with them are employed in combination. After coating the primer composition on the lens substrate and conducting a thermosetting treatment or UV curing treatment, the urethane-forming monomers link neighboring polyurethane resin particles. Since the polyurethane resin particles are linked by urethane-forming monomer components, the primer layer obtains the ability to propagate shock waves accompanying an impact in a direction perpendicular to sideways and the impact is not concentrated in one spot, which is thought to enhance impact resistance.

### (C) The Oxide Microparticles

The oxide microparticles are not specifically limited. Examples are: titanium oxide, zirconium oxide, aluminum oxide, silicon oxide, niobium oxide, tantalum oxide, tin oxide, antimony oxide, and composite oxides thereof.

Among these composite oxide microparticles, at least a portion of the composite oxides can be hydrated or oxidized. The average particle diameter of the composite oxide microparticles employed in the present invention is 1 to 800 nm, desirably 2 to 300 nm. When the average particle diameter exceeds 800 nm, the coating obtained tends to cloud over and become opaque. Conversely, an average particle diameter of less than 1 nm tends to preclude an adequate refractive index.

The composite oxide microparticles are desirably comprised of oxides of (i) titanium, (ii) silicon, and (iii) zirconium. The mode of composite can be:

(A-1) microparticles comprising cores in the form of titanium oxide microparticles coated with zirconium oxide and silicon oxide;
(A-2) microparticles comprising cores in the form of composite oxide microparticles of a solid solution of titanium oxide, zirconium oxide, and/or aluminum oxide, that are coated with silicon oxide and zirconium oxide;
(A-3) microparticles comprising cores in the form of composite oxide microparticles of a solid solution of titanium oxide and silicon oxide, the surface of these core microparticles being coated with silicon oxide, zirconium oxide, and/or aluminum oxide; or
(A-4) microparticles comprising cores in the form of composite oxide microparticles of a solid solution of titanium oxide, silicon oxide, zirconium oxide, and/or aluminum oxide, the surface of these core microparticles being coated with silicon oxide, zirconium oxide, and/or aluminum oxide.

When titanium oxide is contained among the core microparticles, a composite oxide microparticle of high refractive index is obtained. Not exposing the titanium oxide on the surface of the composite oxide microparticles enhances the weatherability of the primer layer. Components (A-1) to (A-4) will be described in detail below.

Composite (A-1) is as described below. The refractive index of titanium oxide exhibits a value falling within a range of 2.2 to 2.7 depending on crystalline structures, and is thus higher than the refractive indexes of the oxides of Al, Zr, Sn, and Sb. However, titanium oxide is activated by the absorption of UV light from 230 to 320 nm. To inhibit the activation of titanium oxide, it suffices to coat the surface of core microparticles comprised of titanium oxide with an oxide such as zirconium oxide and/or aluminum oxide and silicon oxide.

Zirconium oxide and/or aluminum oxide is selected as the oxide for coating the surface because it improves the chemical properties of the cured film obtained in the end, such as weatherability (lack of coloration) and water repellency. However, when just zirconium oxide and/or aluminum oxide is employed, aggregation tends to occur in the primer composition and fogging (clouding) tends to occur in the primer layer. Thus, such aggregation is prevented and the uniformity of dispersion of the primer composition is ensured when silicon oxide is employed with the zirconium oxide and/or aluminum oxide. In the oxide used to coat the layer, the atomic ratio of silicon, zirconium, and/or aluminum (Zi/Si) is 0.001 to 1,000, desirably 1 to 10. When the quantity of zirconium oxide increases to a certain level, the state of dispersion of the oxide microparticles deteriorates. When the ratio of silicon oxide becomes excessively high, the refractive index decreases, or weatherability and water repellency deteriorate.

In the composite oxide microparticles, the ratio of the weight (W1) of the core microparticles to the weight (W2) of the oxide covering the surface is desirably 0.001 to 100, preferably 0.01 to 1.

In composite (A-2), the core microparticles are comprised of titanium oxide, zirconium oxide, and/or aluminum oxide. Adding zirconium oxide and/or aluminum oxide to the core microparticles further inhibits the above-described activity of titanium oxide. Further, zirconium oxide and/or aluminum oxide undergo little coloration, yielding a composite microparticles with less coloration. For composite (A-2), the effect of the zirconium oxide and/or aluminum oxide is achieved when the atomic ratio of titanium to zirconium and/or aluminum (Zr/Ti) is about 0.01. When the quantity of zirconium oxide reaches a certain level, the refractive index drops. Thus, an atomic ratio of 10 or lower is desirable. The oxides covering the surface is identical to those in (A-1).

In composite (A-3), the core microparticles are comprised of titanium oxide and silicon oxide. Incorporating silicon oxide into the microparticles further inhibits the above activity of titanium oxide. Further, incorporating silicon oxide also improves chemical properties, such as weatherability (lack of coloration) and water repellency. In composite (A-3), the effect of silicon oxide is achieved at an atomic ratio of silicon to titanium (Si/Ti) of about 0.01. When the quantity of silicon oxide reaches a certain level, the refractive index drops. Thus, an atomic ratio of 10 or lower is desirable. The oxides covering the surface is identical to those in (A-1).

In composite (A-4), the core particles are comprised of titanium oxide, silicon oxide, zirconium oxide, and/or aluminum oxide. Incorporating silicon oxide, zirconium oxide, and/or aluminum oxide into the core particles further inhibits the above activity of titanium oxide. Further, incorporating silicon oxide improves chemical properties, such as weatherability (lack of coloration) and water repellency. Incorporating zirconium oxide prevents coloration of the particles that have been compounded. In composite (A-4), an effect is produced by the addition of zirconium oxide at an atomic ratio of zirconium to titanium and/or aluminum (Zr/Ti) of about 0.01. The effect produced by the addition of silicon oxide is achieved at an atomic ratio of silicon to titanium (Si/Ti) of about 0.01. Further, when the quantity of zirconium oxide and/or aluminum oxide and silicon oxide increases to a certain level, the refractive index drops. Thus, the atomic ratio of the sum of the silicon, zirconium, and/or aluminum to the titanium ((Si+Zr)/Ti) is desirably 10 or lower. The oxides covering the surface is identical to those in (A-1).

To maintain the composite oxide microparticles in a stable state of dispersion, and to enhance water repellency, the surface can be processed with a variety of organic acids, alkalis, organic silicon compounds, silicon oxide, and the like. Examples of organic acids that can be used for treatment are citric acid and tartaric acid. Examples of alkalis are organic amines, ammonia, and aqueous solutions of salts or hydroxides of alkali metals such as Na and K. Examples of organic silicon compounds are silane coupling agents such as gamma-glycidoxypropyltrimethoxysilane and gamma-methacryloxypropyltrimethoxysilane, as well as organic silanes such as methyltrichlorosilane and tetramethoxysilane.

The oxide microparticles are desirably present in a colloid obtained by dispersion in water or an organic solvent. Storage in colloid form ensures the dispersibility of the oxide microparticles. Examples of the organic solvent employed as the dispersion medium are alcohols such as methanol and ethanol, as well as ethyl cellosolve and methyl cellosolve.

The quantity of oxide microparticles added can be suitably determined in consideration of the refractive index of the primer layer. When forming a primer layer of high refractive index, the quantity of oxide microparticles can be increased.

The oxide microparticles are desirably dispersed in advance in the urethane-forming monomer solution and/or polyurethane resin solution. Dispersing the oxide microparticles in the urethane-forming monomer solution and polyurethane resin solution in advance enhances the dispersibility of the oxide microparticles. This is advantageous in that it prevents uneven distribution of the oxide microparticles and yields a homogenous primer layer from the primer composition that has been prepared.

When a primer layer is formed with a composition solution comprised of a polyurethane resin emulsion and an oxide sol, oxide microparticles enter between the polyurethane resin particles. Sites where the oxide microparticles have entered become brittle, and are thought to compromise impact resistance. By contrast, in the present invention, urethane-forming monomer and metal microparticles enter into the gaps between polyurethane resin particles. Since the polyurethane resin particles are linked by urethane-forming monomer, even when the oxide microparticles enter between the polyurethane resin particles, brittle spots do not develop. As a result, in the present invention, a drop in the impact resistance of the primer layer is inhibited. Further, by containing dispersed oxide microparticles, the primer composition of the present invention permits the formation of a primer layer having good impact resistance while having a high refractive index. As a result, a lens can be obtained that has good impact resistance and in which an interference fringe is not produced even by a lens substrate with a high refractive index.

### (D) The Solvent

Solvent can be incorporated into the primer composition to adjust the concentration of the solid component and to adjust the surface tension, viscosity, rate of evaporation, and the like of the coating liquid. The solvent can be water or an organic solvent added to water.

Specific examples of the organic solvent are alcohols such as methanol, ethanol, and isopropyl alcohol; cellosolves such as methyl cellosolve and ethyl cellosolve; glycols such as ethylene glycol; esters such as methyl acetate and ethyl acetate; ethers such as diethyl ether and tetrahydrofuran; ketones such as acetone and methyl ethyl ketone; halogenated hydrocarbons such as dichloroethane; aromatic hydrocarbons such as toluene and xylene; carboxylic acids; and N,N-dimethyl formamide. Two or more of these solvents can be combined for use.

In the present invention, as the organic solvent, an aprotic polar solvent in the form of N-methylpyrrolidine (NMP) or dimethyl formamide (DMF), or with dimethyl acetamide (DMA), dimethyl sulfoxide (DMSO) or the like can be employed. In particular, a primer composition exhibiting good sol dispersibility and good temperature properties such as stability can be obtained when N-methylpyrrolidine (NMP) is employed.

An aqueous emulsion polyurethane is employed in the polyurethane resin particles employed in the primer composition of the present invention. The solvent is aqueous. An organic solvent is employed in the urethane-forming monomer and/or oligomer. Examples of the organic solvent employed in the urethane-forming monomer and/or oligomer are: methanol, diacetone alcohol, 1-methoxy-2-propanol acetate and the like. Since NMP is a strong polar solvent, it has good compatibility with the aqueous solvent (principally water) of the aqueous polyurethane as well as good compatibility with the above organic solvents. Thus, using NMP affords the advantages of inhibiting the aggregation and precipitation of materials such as the polyurethane resin particles and oxide microparticles contained in the primer composition.

Conventionally, NMP has seldom been employed as a solvent in coating liquids such as primer compositions. This is because NMP, with its high boiling point of 202° C., tends not to evaporate. However, due to its high boiling point, NMP evaporates little even when employed to apply a spin coating so that the composition of the coating liquid varies little before use and during recycling. Thus, the sol comprising the primer composition and the dispersion state of the urethane varies little. A primer composition containing NMP affords the advantage of permitting the ready reuse of the spin coat liquid. In a conventional primer, the ratio of low-boiling-point components (such as methanol) in the solvent is high, rendering reuse of the spin coat liquid difficult. The low-boiling-point components evaporate during spin coating so that the primer material liquid must be replenished with a large amount of solvent during recycling, or the dispersion process must be conducted anew.

When utilizing the functions of NMP, NMP is suitably employed in a quantity ranging from 10 to 75 weight percent, preferably a range of 40 to 70 weight percent, of the total quantity of the primer composition.

Additionally, leveling agents, lubricants, UV radiation absorbing agents, oxidation inhibitors, antistatic agents, bluing agents and the like can be optionally incorporated into the primer composition of the present invention. Polymer crosslinking agents and catalysts promoting crosslinking reactions can also be incorporated. Desirable leveling agents and lubricants include copolymers of polyoxyalkylene and polydimethyl siloxane and copolymers of polyoxyalkylene and fluorocarbons in particular. They are incorporated into the primer composition in a ratio of 0.001 to 10 weight percent, for example.

The primer composition is applied to at least one surface of the plastic substrate, thereby yielding the plastic lens having a transparent lamination of coatings of the present invention.

The plastic substrate is not specifically limited. Examples are polycarbonates, acrylic resins, polyurethane resins, and episulfide polymers. When the transparent plastic substrate is an eyeglass lens substrate, desirable examples are polyurethane resins, polymethacrylic resins, polyacrylic resins, and episulfide polymers.

The material of the plastic substrate employed in the present invention is not specifically limited. Examples are methyl methacrylate homopolymer, copolymers of methyl methacrylate and one or more other monomers, diethylene glycol bisallyl carbonate homopolymers, copolymers of diethylene glycol bisallyl carbonate and one or more other monomers, sulfur-containing copolymers, halogen-containing copolymers, polycarbonate, polystyrene, polyvinyl chloride, unsaturated polyesters, polyethylene terephthalate, polyurethanes, and polythiourethanes.

The primer composition can be coated on these transparent plastic substrates by, for example, dipping, flowing, spin coating, or spraying. After application, the film can be cured by heating at 50 to 90° C. for from several minutes to 30 minutes, for example. The thickness of the coating is desirably 0.1 to 5 micrometers, preferably 0.2 to 3 micrometers. At a thickness of less than 0.1 micrometer, there is little improvement in impact resistance. At a thickness of greater than 5 micrometers, a drop in hardness is exhibited after providing a hard coat.

The transparent laminate of the present invention may further comprise a hard coat on the outer surface of the coating comprised of the above primer composition. The hard coat is a silicon resin film, desirably comprised of, for example, (D) the sol of an inorganic oxide comprised of microparticles 1 to 100 nm in diameter selected from among the group consisting of oxides of the elements Si, Al, Sn, Sb, Ta, Ce, La, Fe, Zn, W, Zr, In, and Ti, and (E) the epoxy-containing silicon compound denoted by formula (2), or a hydrolysate thereof:

R³R⁴_{d}Si(OR⁵)_{3-d} (2)

wherein R³ denotes a group comprising 2 to 12 carbon atoms and an epoxy group; R⁴ denotes an alkyl group, a halogenated alkyl group having 1 to 6 carbon atoms, an alkenyl group having 2 to 6 carbon atoms, a phenyl group, or a halogenated phenyl group; R⁵ denotes a hydrogen atom, alkyl group having 1 to 4 carbon atoms, or acyl group; and d denotes 0, 1, or 2.

The sol of the above inorganic oxide enhances the hardness, heat resistance, and weatherability of the hard coat. The inorganic oxide microparticles of an oxide such as Ti or Zr serve to raise the refractive index of the hard coat to close to that of the primer coating and prevent the generation of an interference fringe. Examples of the inorganic oxide are: SiO₂, Al₂O₃, SnO₂, Sb₂O₅, Ta₂O₅, CeO₂, La₂O₃, Fe₂O₃, ZnO, WO₃, ZrO₂, In₂O₃, and TiO₂. The inorganic oxide desirably has a particle diameter of 1 to 100 micrometers.

To enhance dispersibility in the solvent, the inorganic oxide can optionally be subjected to surface treatment with an organic silane compound. The surface treatment can be conducted with an organic silane compound or a hydrolysate thereof. The organic silane compound is desirably employed in a ratio of 20 weight percent or less of the inorganic oxide.

Examples of the organic silicon compound are the compounds of formulae (3), (4), (5), and (6):

R⁶₃SiX (3)

Here, the multiple instances of R⁶ may be identical or different, independently denoting organic groups such as alkyl groups, phenyl groups, vinyl groups, methacryloxy groups, mercapto groups, amino groups, or epoxy groups, and X denotes a hydrolyzable group.

R⁶₂SiX₂ (4)

Here, R⁶ and X are defined as in formula (3). The multiple instances of X may be identical or different.

R⁶SiX₃ (5)

Here, R⁶ and X are defined as in formula (3).

SiX₄ (6)

Here, X is defined as in formula (3). Examples of the compound denoted by formula (3) are: trimethylmethoxysilane, triethylmethoxysilane, trimethylethoxysilane, triethylethoxysilane, triphenylmethoxysilane, diphenylmethylmethoxysilane, phenyldimethylmethoxysilane, phenyldimethylethoxysilane, vinyldimethylmethoxysilane, vinyldimethylethoxysilane, gamma-acryloxypropyldimethylmethoxysilane, gamma-methacryloxypropyldimethylmethoxysilane, gamma-mercaptopropyldimethylmethoxysilane, gamma-mercaptopropyldimethylethoxysilane, N-beta-(aminoethyl)-gamma-aminopropyldimethylmethoxysilane, gamma-aminopropyldimethylmethoxysilane, gamma-aminopropyldimethylethoxysilane, gamma-glycidoxypropyldimethyl-methoxysilane, gamma-glycidoxypropyldimethoxyethoxysilane, and beta-(3,4-epoxycyclohexyl)ethyldimethylmethoxysilane.

Examples of the compound denoted by formula (4) are: dimethyldimethoxysilane, diethyldimethoxysilane, dimethyldiethoxysilane, diethyldiethoxysilane, diphenyldimethoxysilane, phenylmethoydimethoxysilane, phenylmethyldiethoxysilane, vinylmethyldimethoxysilane, vinylmethyldiethoxysilane, gamma-acryloxypropylmethyldimethoxysilane, gamma-methacryloxypropyldimethyldimethoxy, gamma-mercaptopropyl-methyldimethoxysilane, gamma-mercaptopropylmethyldiethoxysilane, N-beta-(aminoethyl)-gamma-aminopropylmethyldimethoxysilane, gamma-aminopropylmethyldimethoxysilane, gamma-aminopropylmethyldiethoxysilane, gamma-glycidoxypropylmethyldimethoxysilane, gamma-glycidoxypropylmethoxydiethoxysilane, and beta-(3,4-epoxycyclohexyl)ethylmethyldimethoxysilane.

Examples of the compound denoted by formula (5) are: methyltrimethoxysilane, ethyltrimethoxysilane, methyltriethoxysilane, ethyltriethoxysilane, phenyltrimethoxysilane, phenyltriethoxysilane, vinyltrimethoxysilane, vinyltriethoxysilane, vinyl(beta-methoxyethoxy)silane, gamma-acryloxypropyltrimethoxysilane, gamma-methacryloxy-propyltrimethoxysilane, gamma-mercaptopropyltrimethoxysilane, gamma-mercaptopropyltriethoxysilane, N-beta-(aminoethyl)-gamma-aminopropyltrimethoxysilane, gamma-aminopropyltrimethoxysilane, gamma-aminopropyltriethoxysilane, gamma-glycidoxypropyltrimethoxysilane, beta-glycidoxypropyltrimethoxysilane, gamma-glycidoxypropyltriethoxysilane, beta-glycidoxypropyltriethoxysilane, and beta-(3,4-ethoxycyclohexyl)ethyltrimethoxysilane.

Examples of the compound denoted by formula (6) are tetraethylorthosilicate and tetramethylorthosilicate.

Examples of the dispersion medium employed in the sol of the above inorganic oxide are water, saturated aliphatic alcohols, cellosolves, propylene glycol derivatives, esters, ethers, ketones, aromatic hydrocarbons, and other solvents.

Examples of the saturated aliphatic alcohols are methanol, ethanol, isopropyl alcohol, n-butanol, 2-butanol and the like. Examples of the cellosolves are methyl cellosolve, ethyl cellosolve, propyl cellosolve, butyl cellosolve and the like. Examples of the propylene glycol derivatives are propylene glycol monomethyl ether, propylene glycol monoethyl ether, propylene glycol monomethyl acetate and the like. Examples of the esters are methyl acetate, ethyl acetate, butyl acetate and the like. Examples of the ethers are diethyl ether methyl isobutyl ether and the like. Examples of the ketones are acetone, methyl isobutyl ketone and the like. Examples of the aromatic hydrocarbons are xylene, toluene and the like. Examples of other solvents are ethylene glycol, tetrahydrofuran, N,N-dimethylformamide, dichloroethane and the like.

The content of the inorganic oxide is, for example, 5 to 80 weight parts, desirably 10 to 40 weight parts, per 100 weight parts of sol.

A further component constituting the hard coat composition is the epoxy-containing silicon compound denoted by formula (2) above, or a hydrolysate thereof. The epoxy-containing silicon compound or hydrolysate thereof is desirably incorporated into the hard coat composition in a ratio of 5 to 60 weight percent.

Examples of the epoxy-containing silicon compound are gamma-glycidoxypropyltrimethoxysilane, beta-glycidoxypropyltrimethoxysilane, gamma-glycidoxypropyltriethoxysilane, beta-glycidoxypropyltriethoxysilane, gamma-glycidoxypropylmethyldimethoxysilane, gamma-glycidoxypropylmethyldiethoxysilane, beta-(3,4-epoxycyclohexyl)ethyltrimethoxysilane and the like.

Examples of the dispersion medium employed in the hard coat composition are alcohols, aliphatic cyclic ketones, acetic esters, alcohols, and other solvents.

Examples of the alcohols are ethylene glycol monomethyl ether acetate, ethylene glycol monoethyl ether acetate, ethylene glycol monopropyl ether acetate, ethylene glycol monobutyl ether acetate, propylene glycol monomethyl ether acetate, propylene glycol monoethyl ether acetate, propylene glycol monopropyl ether acetate, propylene glycol monobutyl ether acetate, ethylene glycol dimethyl ether, ethylene glycol diethyl ether, ethylene glycol dipropyl ether, ethylene glycol dibutyl ether, diethylene glycol dimethyl ether, diethylene glycol diethyl ether, diethylene glycol dipropyl ether, diethylene glycol dibutyl ether, propylene glycol dimethyl ether, propylene glycol diethyl ether, propylene glycol monomethyl ether, ethylene glycol monoethyl ether, ethylene glycol monobutyl ether and the like.

Examples of the aliphatic cyclic ketones are cyclohexanone, o-methylcyclohexanone, m-methylcyclohexanone, and p-methylcyclohexanone. Examples of the acetic esters are ethyl acetate, n-propyl acetate, and n-butyl acetate. Examples of the alcohols are methanol, ethanol, 1-propanol, 2-propanol, and 1-butanol. Additionally, solvent naphtha and methyl ethyl ketone can be employed. The hard coat composition desirably comprises 1 to 10-fold the theoretical stoichiometric quantity of water to hydrolyze the epoxy-containing silicon compound of formula (2) above.

The hard coat compositions further comprises a curing catalyst. Examples of the curing catalyst are: chelate compounds, fatty acid salts, primary to tertiary amines, polyalkyleneamines, sulfonates, magnesium perchlorate, ammonium perchlorate and the like. These compounds may be used in combination with an organic mercaptan and mercaptoalkylenesilane. Examples of the chelate compounds are those in which the metal center is Al, Zr, Co, Zn, Sn, Mn, V, Cu, Ce, Cr. Ru, Ga, Cd, and Fe, and the ligands are acetyl acetone, di-n-butoxyde-monoethyl acetate, di-n-butoxidemonomethyl acetate, methyl ethyl ketooxime, 2,4-hexanedione, 3,5-heptadione, or acetoxime. Examples of the fatty acid salts are metal salts of 2-ethylhexanoic acid, stearic acid, lauric acid, oleic acid, acetic acid, sebacic acid, dodecanedioic acid, propionic acid, brassic acid, isobutyric acid, citraconic acid, and acetic acids such as diethyleneaminetetraacetic acid. More specific examples of these chelate compounds and fatty acid salts are alkali metal salts and ammonium salts of carboxylic acids, metal salts and aluminum salts of acetylacetone, metal salts of ethyl acetoacetate, and metals salts coordinated with acetylacetone and ethyl acetoacetate. The primary to tertiary amine is desirably a fatty amine, aromatic amine, or aminosilane. Examples are: polymethylene diamine, polyether diamine, diethylene triamine, iminobispropylamine, bishexamethylene triamine, diethylene triamine, tetraethylene pentamine, pentaethylene hexamine, dimethyl aminopropyl amine, aminoethyl ethanol amine, methyl iminobispropyl amine, methane diamine, N-aminomethyl piperazine, 1,3-diaminocyclohexane, isophorone diamine, metaxylylene diamine, tetrachloroparaxylene diamine, metaphenylene diamine, 4,4′-methylene dianiline, diaminodiphenylsulfone, benzidine, toluidine, diaminodiphenyl ether, 4,4′-tiodianiline, 4,4′-bis(o-toluidine)dianisidine, o-phenylenediamine, 2,4-toluenediamine, methylenebis(o-chloroaniline), diaminoditolylsulfone, bis(3,4-diaminophenyl)sulfone, 2,6-diaminopyridine, 4-chloro-o-phenylenediamine, 4-methoxy-6-methyl-m-phenylenediamine, m-aminobenzylamine, N,N,N′,N′-tetramethyl-1,3-butanediamine, N,N,N′,N′-tetramethyl-p-phenylenediamine, tetramethylguanidine, triethanolamine, 2-dimethylamino-2-hydroxypropane, N,N′-dimethylpiperazine, N,N′-bis[(2-hydroxy)propyl]piperazine, N-methylformolin, hexamethylenetetramine, pyridine, pyrazine, quinoline, benzyldimethylamine, alpha-methylbenzylmethylamine, 2-(dimethylaminomethyl)phenol, 2,4,6-tris(dimethylaminomethylol)phenol, N-methylpiperazine, pyrrolidine, morpholine, N-beta-(aminoethyl)-gamma-amino-propyltrimethoxysilane, gamma-aminopropyltrimethoxysilane, gamma-aminopropyltriethoxysilane, N-beta-(aminoethyl)-gamma-aminopropylmethyldimethoxysilane, gamma-aminopropylmethyldimethoxysilane, and gamma-aminopropylmethyldiethoxysilane.

Additionally, leveling agents, lubricants, UV radiation absorbing agents, oxidation inhibitors, antistatic agents, bluing agents, and the like can optionally be incorporated into the above hard coat composition. In particular, desirable examples of leveling agents and lubricants are copolymers of polyoxyalkylene and polydimethylsiloxane and copolymers of polyoxyalkylene and fluorocarbons. They are incorporated into the hard coat composition in a ratio of 0.001 to 10 weight percent, for example.

The hard coat composition can be coated on the primer coating on the transparent laminate by, for example, dipping, flowing, spin coating, spraying and the like. After application, the film can be cured by heating at a temperature of 90 to 120° C. for from 1 to 24 hours, for example. The thickness of the coating is desirably 0.5 to 5 micrometers, preferably 1.0 to 4.0 micrometers. At a thickness of less than 0.5 micrometer, hardness decreases. At a thickness of greater than 5 micrometers, cracks tend to form.

On the plastic lens having a transparent laminate of the present invention, an antireflective coating can be provided over the hard coat. Providing an antireflective coating comprised of a single layer or multiple layers of an inorganic material over the hard coat lowers reflection, enhances transmittance, and improves weatherability.

A thin film of an inorganic compound such as SiO, SiO₂, Si₃N₄, TiO₂, ZrO₂, Al₂O₃, MgF₂, Ta₂O₅ or the like, is formed by vacuum deposition or the like.

In the course of providing the hard coat, it is effective to subject the lens substrate to a pretreatment such as an alkali treatment, acid treatment, plasma treatment, corona treatment, flame treatment, or the like to improve the adhesive properties of the hard coat.

The transparent laminate of the present invention is suited to plastic lenses for eyeglasses. It is also suited to safety goggles requiring impact resistance and transparent plastic sheets requiring impact resistance.

Examples of desirable antireflective films are multilayered antireflective films applied in alternating high-refractive-index and low-refractive-index layers. The method of forming the multilayered antireflective film is not specifically limited. Examples of vapor deposition methods are vacuum vapor deposition using an inorganic oxide as the vapor generation source and ion-assisted vapor deposition in which a vapor generation source in the form of a metal is oxidized in a chamber. The low-refractive-index layers of the antireflective film are comprised of SiO₂ or a composite oxide of Si and Al. The high-refractive-index layers of the antireflective film are comprised of TiO₂, ZrO₂, Nb₂O₃, Al₂O₃, Ta₂O₅ and/or Y₂O₅. The antireflective layer may also comprise a hybrid layer in which an organic compound is vapor deposited synchronously with vapor deposition of the inorganic oxide. A water-repellent coat and/or antifogging coat can also be formed over the antireflective film.

Desirable forms of the multilayered antireflective film are given below. In these forms, the first layer is the layer of the antireflective film that is closest to the lens.

Desirable form 1:
Layer 1: SiO₂ layer (thickness: 20-50 nm)
Layer 2: Nb₂O₃ layer (thickness: 3-10 nm)
Layer 3: SiO₂ layer (thickness: 130-250 nm)
Layer 4: Nb₂O₃ layer (thickness: 25-40 nm)
Layer 5: SiO₂ layer (thickness: 30-45 nm)
Layer 6: Nb₂O₃ layer (thickness: 25-50 nm)
Layer 7: SiO₂ layer (thickness: 80-120 nm)
Desirable form 2 (antireflective film):
Layer 1: SiO₂ layer (thickness: 30-60 nm)
Layer 2: Ta₂O₅ layer (thickness: 10-30 nm)
Layer 3: SiO₂ layer (thickness: 200-300 nm)
Layer 4: Ta₂O₅ layer (thickness: 40-70 nm)
Layer 5: SiO₂ layer (thickness: 20-50 nm)
Layer 6: Ta₂O₅ layer (thickness: 40-70 nm)
Layer 7: SiO₂ layer (thickness: 100-150 nm)

Both the first and second desirable forms given above are shown as having seven-layer configurations. However, they are not limited to seven-layer configurations. Antireflective layers with five-layer and three-layer configurations are also possible.

### Embodiments

The present invention is described in greater detail through embodiments below.

### <Evaluation Methods>

### Ordinary Temperature Storage Test of the Primer Composition Liquid

The test was conducted at ordinary temperature (23° C., 60 percent humidity), and primer composition liquids that showed no change were denoted by “A” and primer composition liquids that clouded, became tacky, or otherwise failed to function properly were denoted by “B”. The results are given in Table 5.

Evaluation of Impact Resistance

Impact resistance: A steel ball drop test was conducted in accordance with FDA specifications. In the drop test, a roughly 16.4 g steel ball was released from a height of 127 cm above the center of the lens and allowed to fall naturally. Those that did not crack passed.

A: passed
B: failed

Evaluation of Adhesion

One hundred crosscuts were made at intervals of 1.5 mm in the cured film. Adhesive tape (product name: cellophane tape, made by Nichiban (Ltd.)) was forcefully adhered where the crosscuts had been made, the adhesive tape was quickly peeled off, and the presence or absence of separation of the cured film was examined. The evaluation scale was as given below.

| | |
|---|---|
| A | No separation |
| B | 1 to 10 separations |
| C | 11 to 50 separations |
| D | 51 to 100 separations |

### Evaluation of Clouding

The cured film was visually inspected for clouding under fluorescent lighting in a darkroom. The evaluation scale was as given below.

| | |
|---|---|
| A | No visible clouding |
| B | Almost no visible clouding |
| C | Little visible clouding |
| D | Substantial visible clouding |

The primer composition of the embodiment was prepared as follows. First, liquid A (Optolake (registered trademark) regulated liquid, made by Catalysts & Chemicals Industrial Co., Ltd.) comprised of a sol of titanium zirconium oxide microparticles, liquid B (Crystalcoat (registered trademark) regulated solution, made by SDC Technologies Asia, Ltd.) comprised of polyol+isocyanate+titanium zirconium oxide microcrystals, and liquid D (Adecabontiter (registered trademark) HUX232, made by Adeka K.K.) comprised of an emulsion of aqueous polyurethane resin particles, were first obtained. The compositions of these liquids were as follows (see Tables 1 to 3).

TABLE 1
Liquid A

| Component | Ratio (weight percent) |
|---|---|
| Alcohol-based solvent | 70 |
| Titanium, silicon, zirconium oxide | 30 |

TABLE 2
Liquid B

| Component | Ratio (weight percent) |
|---|---|
| Alcohol-based solvent | 72 |
| Polyol + isocyanate | 15 |
| Titanium, silicon, zirconium oxide | 13 |

TABLE 3
Liquid D

| Component | Ratio (weight percent) |
|---|---|
| Aqueous polyurethane resin particles | 30 |
| Aqueous solvent | 70 |

### Sample 1: Preparation of Composition

Preparation of composition: To 10 weight parts of liquid A were admixed 22.5 weight parts of liquid B. To the mixed liquid were added 50 weight parts of the solvent NMP. Next, 17.5 weight parts of liquid D were added dropwise and the mixture was stirred for 1 hour, yielding 100 weight parts of a prepared liquid. A surfactant was added to this prepared liquid and the mixture was stirred for 24 hours. The solution obtained was filtered with a 0.5 micrometer filter to obtain a primer composition.

### Sample 2: Preparation of Composition

Preparation of composition: To 14.5 weight parts of liquid A were admixed 19 weight parts of liquid B. To the mixed liquid were added 50 weight parts of the solvent NMP. Next, 16.5 weight parts of liquid D were added dropwise and the mixture was stirred for 1 hour, yielding 100 weight parts of a prepared liquid. A surfactant was added to this prepared liquid and the mixture was stirred for 24 hours. The solution obtained was filtered with a 0.5 micrometer filter to obtain a primer composition.

Sample 3: Preparation of Composition (without Sol or Monomer)

Preparation of Sample 3: To 50 weight parts of NMP were added dropwise 50 weight parts of liquid D and the mixture was stirred for 1 hour to obtain 100 weight parts of a prepared liquid. A surfactant was added to this prepared liquid and the mixture was stirred for 24 hours. The solution obtained was filtered with a 0.5 micrometer filter to obtain a primer composition.

Sample 4: Preparation of Composition (without Polymer)

Preparation of Sample 4: To 50 weight parts of liquid B were added 50 weight parts of the solvent NMP and the mixture was stirred for 1 hour to obtain 100 weight parts of a prepared liquid. A surfactant was added to this prepared liquid and the mixture was stirred for 24 hours. The solution obtained was filtered with a 0.5 micrometer filter to obtain a primer composition.

Sample 5: Preparation of Composition (without Monomer)

Preparation of composition: To 20 weight parts of liquid A were added 50 weight parts of the solvent NMP. Thirty weight parts of liquid D were then added dropwise and the mixture was stirred for 1 hour to obtain 100 weight parts of a prepared liquid. A surfactant was added to this prepared liquid and the mixture was stirred for 24 hours. The solution obtained was filtered with a 0.5 micrometer filter to obtain a primer composition.

Sample 6: Preparation of Composition (without Monomer)

To 25 weight parts of liquid A were added 50 weight parts of the solvent NMP. Twenty-five weight parts of liquid D were then added dropwise and the mixture was stirred for 1 hour to obtain 100 weight parts of a prepared liquid. A surfactant was added to this prepared liquid and the mixture was stirred for 24 hours. The solution obtained was filtered with a 0.5 micrometer filter to obtain a primer composition.

Sample 7: Preparation of Composition (without Monomer)

To 30 weight parts of liquid A were added 50 weight parts of the solvent NMP. Twenty weight parts of liquid D were then added dropwise and the mixture was stirred for 1 hour to obtain 100 weight parts of a prepared liquid. A surfactant was added to this prepared liquid and the mixture was stirred for 24 hours. The solution obtained was filtered with a 0.5 micrometer filter to obtain a primer composition.

Sample 8: Preparation of Composition (with Change in Solvent)

The 50 weight parts of NMP added as solvent to the composition of Sample 1 were replaced with DMF (dimethylformamide) and a primer composition was prepared.

Sample 9: Preparation of Composition (with Change in Solvent)

The 50 weight parts of NMP added as solvent to the composition of Sample 1 were replaced with DMA (dimethylacetoamide) and a primer composition was prepared.

Sample 10: Preparation of Composition (with Change in Solvent)

The 50 weight parts of NMP added as solvent to the composition of Sample 1 were replaced with PGM (propylene glycol monomethyl ether) and a primer composition was prepared.

Sample 11: Preparation of Composition (with Change in Solvent)

In the composition of Sample 1, the solvent component was changed to 25 weight parts of NMP and 25 weight parts of DM (diacetone alcohol) and a primer composition was prepared.

Sample 12: Preparation of Composition (with Change in Solvent)

In the composition of Sample 1, the solvent component was changed to 25 weight parts of NMP and 25 weight parts of DMA, and a primer composition was prepared.

The configurations of the various compositions are given in Table 4. The urethane resin particles, urethane-forming monomer, and oxide microparticles (sol) are indicated as weight percentages based on solid component.

TABLE 4

| | | | | | | | | | | Alcohol- |
|---|---|---|---|---|---|---|---|---|---|---|
| | Poly | Urethane | | | Diacetone | | | | Aqueous | based |
| Sample | urethane | monomer | Sol | NMP | alcohol | DMF | PGM | DMA | solvent | solvent |
| 1 | 5.25 | 2.925 | 6.375 | 50 | — | — | — | — | 12.25 | 23.2 |
| 2 | 4.95 | 2.47 | 7.2 | 50 | — | — | — | — | 1.55 | 23.83 |
| 3 | 15 | — | — | 50 | — | — | — | — | 35 | — |
| 4 | — | 6.5 | 7.5 | 50 | — | — | — | — | — | 36 |
| 5 | 9 | — | 6 | 50 | — | — | — | — | 21 | 14 |
| 6 | 7.5 | — | 7.5 | 50 | — | — | — | — | 17.5 | 17.5 |
| 7 | 6 | — | 9 | 50 | — | — | — | — | 14 | 21 |
| 8 | 5.25 | 2.925 | 6.375 | — | — | 50 | — | — | 12.25 | 23.2 |
| 9 | 5.25 | 2.925 | 6.375 | — | — | — | — | 50 | 12.25 | 23.2 |
| 10 | 5.25 | 2.925 | 6.375 | — | — | — | 50 | — | 12.25 | 23.2 |
| 11 | 5.25 | 2.925 | 6.375 | 25 | 25 | — | — | — | 12.25 | 23.2 |
| 12 | 5.25 | 2.925 | 6.375 | 25 | — | — | — | 25 | 12.25 | 23.2 |

* Samples 8 to 12 were identical to Sample 1 except for the solvent.
* PGM denotes propylene glycol monomethyl ether.

TABLE 5
Ordinary temperature storage test of Primer composition (liquid)

| | 10 days | 30 days |
|---|---|---|
| Sample 1 | A | A |
| Sample 2 | A | A |
| Sample 3 | A | A |
| Sample 4 | A | A |
| Sample 5 | A | A |
| Sample 6 | A | A |
| Sample 7 | A | A |
| Sample 8 | B | — |
| Sample 9 | B | — |
| Sample 10 | B | — |
| Sample 11 | B | — |
| Sample 12 | B | — |

In the compositions of Samples 1 to 7, in which NMP was employed as the principal solvent, no clouding appeared following storage in an ordinary temperature environment. In Samples 8 to 10, clouding appeared before long when stored in an ordinary temperature environment. In Samples 11 and 12, in which about 50 percent of the solvent component was NMP, clouding appeared within 10 days, which was later than in Samples 8 to 10. In Samples 11 and 12, no clouding appeared after 30 days in a cold storage test at 5° C.

When ease of handling in an ordinary use environment was taken into account, the use of NMP as the principal solvent was found desirable.

### (2) Formation of the Primer Layer

As the lens substrate, a plastic lens substrate (refractive index (ne) 1.70, referred to as “lens substrate 1” hereinafter), obtained by reacting 9.3 weight parts of bis(isocyanatomethyl)-1,4-dithiane, 25.7 weight parts of bis(mercaptomethyl)-1,4-dithiane, and 65.0 weight parts of bis(beta-epithiopropyl)sulfide in accordance with the description given in paragraphs [0013] to [0014] in Japanese Unexamined Patent Publication (KOKAI) No. 2001-330701, or English language family member U.S. Patent Application No. 2001-030734 A1, which are expressly incorporated herein by reference in their entirety, was immersed for 300 seconds in a 10 weight percent sodium hydroxide aqueous solution at 60° C. and then washed for 300 seconds with ion-exchange water with the application of 28 kHz ultrasound. It was then pretreated in a series of drying steps in a 70° C. atmosphere.

A coating composition (embodiment or comparative example) was then applied to pretreated lens substrate 1 by spin coating to form a primer layer under conditions of at 120° C. for 20 minutes.

### (3) Formation of the Antireflective Film

The plastic lens substrate on which the primer layer had been formed was placed in a vapor deposition device and heated to 65° C. while evacuating the air. When evacuation had been conducted to 2.7 mPa, electron beam heating was used to vaporize vaporization source materials, forming a first layer of nd=1.46 and nlambda (nλ)=0.08 of SiO₂; a second layer of nd=2.21 and nlambda=0.04 of Nb₂O₅, ZrO₂, and Y₂O₃; a third layer of nd=1.46 and nlambda=0.55 of SiO₂; a fourth layer of nd=2.21 and nlambda=0.12 of Nb₂O₅, ZrO₂, and Y₂O₃; a fifth layer of nd=1.46 and nlambda=0.09 of SiO₂; a sixth layer of nd=2.21 and nlambda=0.17 of Nb₂O₅, ZrO₂, and Y₂O₃; and a seventh layer of nd=1.46 and nlambda=0.28 of SiO₂ as an antireflective film. Here, nd denotes the refractive index and nlambda denotes film thickness.

Lenses were produced with Samples 3 to 5, 9, 10, and 12 and evaluated.

Sample 2 was evaluated for three Samples of differing film thickness. The results are given in Table 6.

TABLE 6

| | | Film | Impact | | |
|---|---|---|---|---|---|
| | Refractive | thickness | resis- | Ad- | |
| | index | (micrometers) | tance | hesion | Clouding |
| Sample 1 | 1.66 | 1.2 | A | B | B |
| Sample 2-1 | 1.66 | 1.1 | A | B | B |
| Sample 2-2 | 1.66 | 1.3 | A | B | B |
| Sample 2-3 | 1.66 | 1.7 | A | B | B |
| Sample 3 | 1.5 lowest | 0.6 | A | B | B |
| Sample 4 | 1.7 | 1.5 | A | C | D |
| Sample 5 | 1.61 | 1.4 | A | B | B |
| Sample 6 | 1.64 | 1.5 | B | B | B |
| Sample 7 | 1.67 | 1.8 | B | B | B |
| Sample 8 | 1.66 | 1.2 | A | B | B |
| Sample 9 | 1.66 | 1.2 | A | B | B |
| Sample 10 | 1.66 | 1.2 | A | B | B |
| Sample 11 | 1.66 | 1.2 | A | B | B |
| Sample 12 | 1.66 | 1.2 | A | B | C |

* Composition liquids were employed in Samples 8 to 12 prior to clouding.

Lenses having primer layers formed with the compositions of Samples 1, 2, and 8 to 12 exhibited good impact resistance, adhesion, refractive indexes, and clouding properties.

Sample 3 exhibited good impact resistance, adhesion, and clouding properties, but had a low refractive index. This was attributed to the fact that no refractive index-raising sol of oxide microparticles was incorporated into Sample 3.

No adhesion was achieved in Sample 4, despite a high refractive index of 1.7 and good impact resistance. Sample 4 did not contain aqueous polyurethane resin particles. This lack of aqueous polyurethane resin particles with good adhesion to the lens was thought to be why adhesion to the lens was not achieved.

No monomer urethane component was incorporated into Samples 5 to 7. The primer layer obtained with the composition liquid of Sample 5 exhibited good impact resistance, adhesion, and clouding properties, but the refractive index, at 1.61, was low. The primer layer obtained from the composition liquid of Sample 6 afforded good adhesion and clouding properties, but the refractive index was a low 1.64 and impact resistance was poor. The primer layer obtained with the composition liquid of Sample 7 afforded good adhesion and fogging and had a relatively high refractive index of 1.67, but impact resistance was poor. The reason impact resistance was not achieved in the lenses of Samples 6 and 7 was thought to be that bonding between polyurethane resin particles blocked the oxide microparticles, hampering the propagation and absorption of the impact by the polyurethane component. In composition liquids containing just polyurethane resin particles without urethane monomer, impact resistance was observed to decrease as the ratio of oxide microparticles increased.

The plastic lens of the present invention can be used as an eyeglass lens. The present invention is useful in the technical field of eyeglasses.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the compositions, the methods and the lenses of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A primer composition comprising (A) polyurethane resin particles, (B) a urethane-forming monomer and/or oligomer, and (C) oxide microparticles.

2. The composition in accordance with claim 1, wherein the weight ratio of (A) polyurethane resin to (B) urethane-forming monomer and/or oligomer, (A):(B), is from 1:9 to 9:1.

3. The composition in accordance with claim 1 or 2, wherein the weight ratio of the sum of (A) polyurethane resin particles and (B) urethane-forming monomer to (C) oxide microparticles, (A)+(B):(C), is from 2:8 to 9:1.

4. The composition in accordance with claim 1, wherein the (A) polyurethane resin particles are manufactured from a polyol compound having a polyester skeleton of number average molecular weight of 200 or more, a chain-extending agent, and a polyisocyanate compound, in the form of an aqueous polyurethane resin having carboxyl groups as functional groups.

5. The composition in accordance with claim 1, wherein the (B) urethane-forming monomer and/or oligomer is selected from the group consisting of polyester polyols comprised primarily of isophthalic acid and polyisocyanate.

6. The composition in accordance with claim 1, wherein the (C) oxide microparticles are comprised of at least (i) titanium oxide.

7. The composition in accordance with claim 6, wherein the composite oxide microparticles are at least one type of microparticle selected from the group consisting of (C-1) to (C-4) below:
(C-1) microparticles comprising cores in the form of titanium oxide microparticles coated with zirconium oxide and silicon oxide;
(C-2) microparticles comprising cores in the form of composite oxide microparticles of a solid solution of titanium oxide, zirconium oxide, and/or aluminum oxide, that are coated with silicon oxide and zirconium oxide;
(C-3) microparticles comprising cores in the form of composite oxide microparticles of titanium and silicon, the surface of these core microparticles being coated with silicon oxide, zirconium oxide, and/or aluminum oxide; and
(C-4) microparticles comprising cores in the form of composite oxide microparticles of titanium, silicon, and zirconium, the surface of these core microparticles being coated with silicon oxide, zirconium oxide, and/or aluminum oxide.

8. The composition in accordance with claim 1, wherein the composition further comprises a solvent.

9. The composition in accordance with claim 8, wherein said solvent is N-methylpyrrolidinone.

10. A method of manufacturing a plastic lens, comprising:
forming a primer layer using a primer-forming composition comprising (A) polyurethane resin particles, (B) a urethane-forming monomer and/or oligomer, and (C) oxide microparticles on at least one surface of a plastic substrate; and
forming a hard coat over said primer layer to obtain a plastic lens sequentially comprising a primer layer and a hard coat on at least one surface of a plastic substrate.

11. The method of manufacturing a plastic lens in accordance with claim 10, wherein the weight ratio of (A) polyurethane resin to (B) urethane-forming monomer and/or oligomer, (A):(B), is from 1:9 to 9:1.

12. The method of manufacturing a plastic lens in accordance with claim 10, wherein the weight ratio of the sum of (A) polyurethane resin particles and (B) urethane-forming monomer to (C) oxide microparticles, (A)+(B):(C), is from 2:8 to 9:1.

13. The method of manufacturing a plastic lens in accordance with claim 10, wherein the (A) polyurethane resin particles are manufactured from a polyol compound having a polyester skeleton of number average molecular weight of 200 or more, a chain-extending agent, and a polyisocyanate compound, in the form of an aqueous polyurethane resin having carboxyl groups as functional groups.

14. The method of manufacturing a plastic lens in accordance with claim 10, wherein the (B) urethane-forming monomer and/or oligomer is selected from the group constituting of polyester polyols comprised primarily of isophthalic acid and polyisocyanate.

15. The method of manufacturing a plastic lens in accordance with claim 10, wherein the (C) oxide microparticles are comprised of at least (i) titanium oxide.

16. The method of manufacturing a plastic lens in accordance with claim 10, wherein the composite oxide microparticles are at least one type of microparticle selected from the group consisting of (C-1) to (C-4) below:
(C-1) microparticles comprising cores in the form of titanium oxide microparticles coated with zirconium oxide and silicon oxide;
(C-2) microparticles comprising cores in the form of composite oxide microparticles of a solid solution of titanium oxide, zirconium oxide, and/or aluminum oxide, that are coated with silicon oxide and zirconium oxide;
(C-3) microparticles comprising cores in the form of composite oxide microparticles of titanium and silicon, the surface of these core microparticles being coated with silicon oxide, zirconium oxide, and/or aluminum oxide; and
(C-4) microparticles comprising cores in the form of composite oxide microparticles of titanium, silicon, and zirconium, the surface of these core microparticles being coated with silicon oxide, zirconium oxide, and/or aluminum oxide.

17. The method of manufacturing a plastic lens in accordance with claim 10, wherein the composition further comprises a solvent.

18. The method of manufacturing a plastic lens in accordance with claim 17, wherein said solvent is N-methylpyrrolidinone.

19. The method of manufacturing a plastic lens in accordance with claim 10, wherein the method further comprises forming an antireflective film on said hard coat to obtain a plastic lens sequentially comprising a primer layer, hard coat layer, and antireflective film on at least one surface of a plastic substrate.

20. The method of manufacturing a plastic lens in accordance with claim 10, wherein said primer layer is formed by spin coating.

21. A plastic lens comprising a primer layer and a hard coat on at least one surface of a plastic substrate, wherein said primer layer manufactured by using a primer-forming composition comprising (A) polyurethane resin particles, (B) a urethane-forming monomer and/or oligomer, and (C) oxide microparticles.

22. The plastic lens in accordance with claim 21, wherein the plastic lens further comprises an antireflective film on the hard coat.

23. The plastic lens in accordance with claim 21 or 22, wherein said plastic lens is an eyeglass lens.
